(19) United States
(12) Patent Application Publication
(10) Pub. No.: US 2008/0092440 A1
(43) Pub. Date: Apr. 24, 2008

(54) Plant Watering and Shading Device

(76) Inventor: Julie S. Johnson, Sarasota, FL (US)

Correspondence Address: QUICKPATENTS, INC., 32861 CALLE PERFECTO, SUITE A, SAN JUAN CAPISTRANO, CA, 92675, US

(21) Appl. No.: 11/552,485

(22) Filed: Oct. 24, 2006

(51) Int. Cl. A01G 29/00; A01G 9/02

(52) U.S. Cl. 47/48.5; 47/66.6

(57) ABSTRACT

A watering and shading device for at least one plant is disclosed. The device comprises an elongated substantially hollow shaft. A top end of the shaft terminates in a preferably flared funnel-shaped opening for receiving water, and a bottom end terminates in a soil-penetrating spike for inserting into soil. The spike includes at least one aperture therein for allowing water to pass from the inside of the hollow shaft therethrough. The device also includes a shading umbrella that comprises at least one non-transparent panel attached at one portion thereof to a shaft attachment means. The umbrella may be selectively placed in a deployed position or a collapsed position at a selected height along the shaft. The shaft includes a valve mechanism therein proximate the bottom end controlled by a moisture detection means for regulating the position of the valve mechanism based upon the soil moisture level. At least one solar-powered lantern may be included, fixed to the shading structure, and activated upon a photovoltaic cell detecting darkening conditions.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to plant husbandry, and more particularly to a combination plant shade and water reservoir apparatus.

### DISCUSSION OF THE RELATED ART

In the field of plant husbandry, often it is desirable to provide certain types of plants shade from direct sunlight in order to promote optimal growth. Plant shades are typically large tent-like structures, but umbrella-like structures have also been used (such as in U.S. Pat. No. 3,706,160 to Deibert on Dec. 19, 1972; U.S. Design Pat. D513,117 to Raede on Dec. 27, 2005; and indirectly in U.S. Pat. No. 6,862,843 to Missry on Mar. 8, 2005. Such patents, and particularly the—160 patent, can provide not only shade to plants but also can often provide frost protection. However, as such shade devices often block rainwater from reaching the plant, separate watering means must be provided with such devices.

Watering devices that allow rainwater to be collected and dispensed to plants are also well-known in the prior art. For example, U.S. Pat. No. 3,896,586 to Caldwell on Jul. 29, 1975 and U.S. Pat. No. 5,918,412 to Shen on Jul. 6, 1999 both teach devices that may collect rain water in a reservoir for eventual disbursement to plants through a perforated ground spike. U.S. Pat. No. 4,336,666 to Caso also teaches a perforated ground spike watering device. Such devices are well suited for providing water to plants over time, from either rain water or manually provided water. However, none of the watering devices additionally provides for shading. The —586 device only provides for covering a young plant, not for shading the plant. Further, such a covering device is not adjustable for varying the degree of covered protection the plant receives.

There are several prior art devices that provide both shade and water to plants. For example, U.S. Pat. No. 6,161,362 to Forbis, Sr. et al. on Dec. 19, 2000, and U.S. Pat. No. 4,366,646 to Pratt on Jan. 4, 1983 teach such devices. The—362 device does not provide means to collect rainwater, and instead includes sprinkler means for delivery pressurized water to plants from a municipal source, for example. The—646 device, on the other hand, makes no provision for adjusting the amount of shade that plants receive. The—646 device, further, is quite bulky and not well-suited to standard house plants in plant pots, for example.

Therefore, there is clearly a need for a plant shade and watering device that allows for fully adjusting the amount of shade afforded to plants. Such a needed device would further allow the plant to be covered for frost protection. Such a needed invention would further collect rainwater or manually introduced water into a reservoir for watering the plant, and would provide means for adjustable water flow therefrom based on the moisture level in the soil proximate the plant. The present invention accomplishes these objectives.

### SUMMARY OF THE INVENTION

The present device is a watering and shading device for at least one plant. The device comprises an elongated substantially hollow shaft having a top end and a bottom end. The top end terminates in a preferably flared funnel-shaped opening for receiving water, and the bottom end terminates in a soil-penetrating spike for inserting into soil. The spike includes at least one aperture therein for allowing water to pass from the inside of the hollow shaft therethrough.

The device also includes a shading structure, such as an umbrella, that comprises at least one non-transparent panel attached at one portion thereof to a shaft attachment means. Preferably the umbrella may be selectively placed in a deployed position or a collapsed position at a selected position along the shaft. As such, the umbrella may provide both shade and frost protection to the plant. In such an embodiment, the shaft attachment means is a first annular collar having an aperture therethrough for receiving the shaft and being fixed thereon. The collar preferably includes a shaft locking means for selectively fixing the position of the first collar on the shaft. A second collar is preferably included for slidable engagement with the shaft independently from the first collar. The second collar is attached to an umbrella deployment mechanism for selectively deploying or collapsing the umbrella. The second collar has a shaft locking means for fixing the position of the second collar on the shaft.

The shaft preferably includes a valve mechanism therein proximate the bottom end. The valve mechanism, when in a closed position, prevents water in the shaft from reaching the bottom end of the shaft. In an open position, the valve mechanism allows water to flow from the shaft into the bottom end of the shaft, and then out through the spike. In one embodiment of the invention, the valve mechanism is a ball valve having a buoyant ball captured within the bottom end of the shaft. A seal within the shaft is adapted to receive the ball against a lower side thereof to close the valve.

A moisture detection means is further preferably included for detecting the moisture content of the soil. The moisture detection means is in electronic communication with a control circuit, which is powered by a power source and regulates the position of the valve mechanism based upon electronic signals received from the moisture detection means.

The shading may further include at least one flexible solar cell on at least one panel thereof for charging a rechargeable battery of at least one lantern. Each lantern is fixed to the shading structure and connected to a lamp circuit that supplies power from the battery to a light emitting means of the lantern when a photovoltaic sensor of the lamp circuit detects an absence of ambient light.

The present invention is a plant shade and watering device that allows for fully adjusting the amount of shade provided to plants. The present device also allows the plant to be covered for frost protection. The present invention collects rainwater or manually introduced water into a reservoir for watering the plant over time, and provides means for adjustable water flow therefrom based on the moisture level in the soil proximate the plant. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective illustration of the invention, illustrating a plant watering and shading device having a water-holding shaft and an umbrella shading structure, the umbrella in a deployed position;

FIG. 2 is a cross-sectional view of the invention, taken generally along lines 2-2 of FIG. 1;

FIG. 3 is a partial cross-sectional view of an alternate embodiment of the invention, illustrating a shaft clamping means for clamping the invention to a plant pot, or the like;

FIG. 4 is a partial cross-sectional view of an alternate embodiment of the invention, illustrating an upper shaft and a lower shaft of a telescoping shaft of the invention; and

FIG. 5 is a partial cross-sectional view of the invention, illustrating an umbrella portion of the invention in a collapsed position.

### DETAILED DESCRIPTION OF THE PREFERRED EMBODIMENT

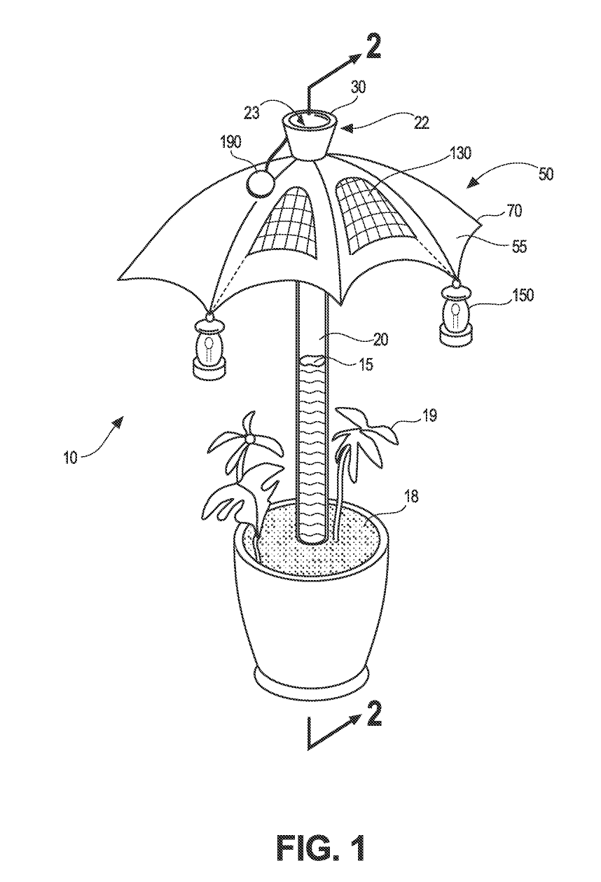

FIG. 1 illustrates a watering and shading device 10 for at least one plant 19. The device 10 comprises an elongated substantially hollow shaft 20 having a top end 22 and a bottom end 24. The top end 22 terminates in a preferably flared funnel-shaped opening 23 for receiving water 15, and the bottom end terminates in a soil-penetrating spike 40 for inserting into soil 18. The spike 40 includes at least one aperture 45 therein for allowing water 15 to pass from the inside of the hollow shaft 20 therethrough. The shaft 20 is preferably made from an extruded plastic tube, injection molded plastic, or the like. A non-porous cover 190 may be further included for attaching to the opening 23 at the top end 22 of the shaft 20 for preventing water 15 from filling the shaft 20. The shaft 20 is preferably transparent or translucent so that the amount of water 15 within the shaft 20 may be readily visible.

In one embodiment of the invention, the shaft 20 is telescoping and as such height-adjustable. In such an embodiment, an upper shaft 26 has a top end and a lower shaft 27 has a bottom end, the lower shaft 27 having an outside diameter of less than an inside diameter of the upper shaft 26, such that the lower shaft 27 may be co-axially inserted into the upper shaft 26 (FIG. 4). At least one elastomeric gasket 28 is further included to prevent water 15 from leaking between the upper and lower shafts 26,27. Additionally, a water-proof, flexible, collapsible portion 29 may be fixed between the upper shaft 26 and the lower shaft 27 whereby water 15 is prevented from leaking from the upper shaft 26 into the lower shaft 27 (FIG. 4). Such a collapsible portion 29 may be an accordion-shaped plastic sheet material formed into a cylinder, for example.

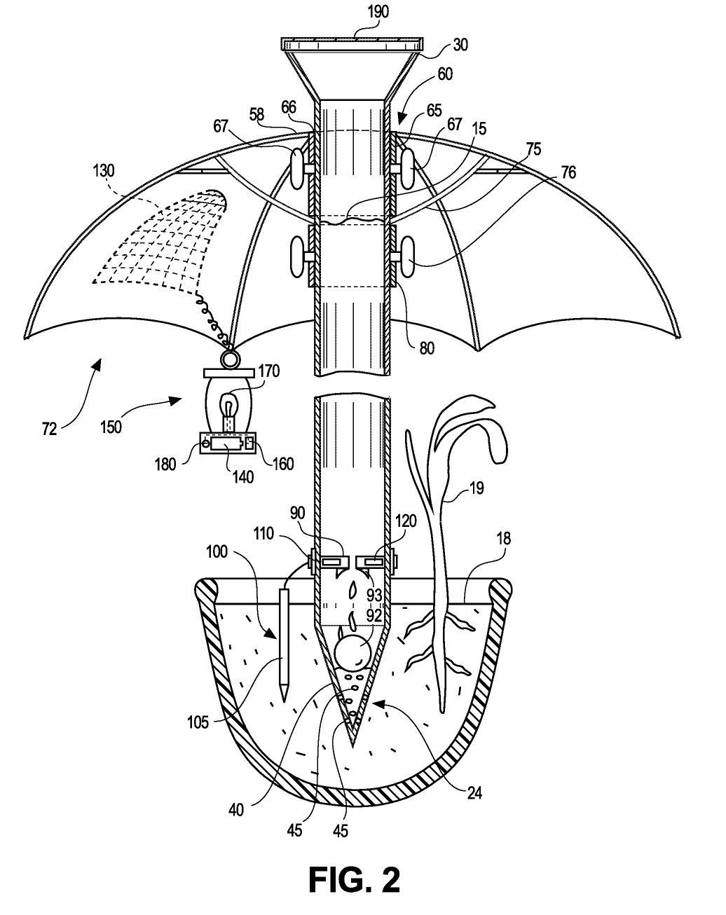

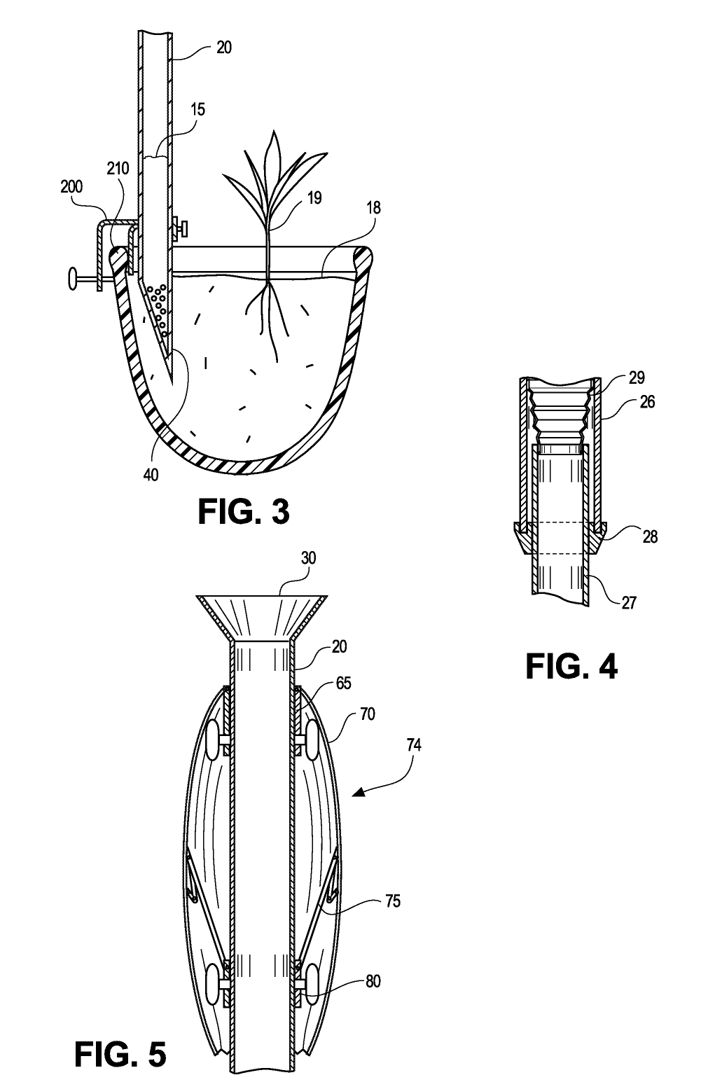

The device also includes a shading structure 50 that comprises at least one non-transparent panel 55 attached at one portion 58 thereof to a shaft attachment means 60 (FIG. 2). Preferably the shading structure 50 is the form of an umbrella 70 capable of being selectively placed in a deployed position 72 (FIG. 1) or a collapsed position 74 (FIG. 5). In such an embodiment, the shaft attachment means 60 is a first annular collar 65 having an aperture 66 therethrough for receiving the shaft 20 and being fixed thereon. The collar 65 preferably includes a shaft locking means 67 for selectively fixing the position of the first collar 65 on the shaft 20. As such, the umbrella 70 may be lowered on the shaft 20 to provide frost protection to the plant 19 as well as shade. A second collar 80 is preferably included for slidable engagement with the shaft 20 independently from the first collar 65. The second collar 80 is attached to an umbrella deployment mechanism 75 for selectively deploying or collapsing the umbrella 70. The second collar 80 has a shaft locking means 76 for fixing the position of the second collar 80 on the shaft 20. The first and second collars 65,80 may be formed from a metal sheet material or injection molded using a plastic material, for example. Each shaft locking means 67,76 may be a manually actuated bolt traversing a threaded aperture in each collar, for example. Other shaft locking means 67,76, such as pins or the like may also be used.

The shaft 20 preferably includes a valve mechanism 90 therein proximate the bottom end 24 (FIG. 2). The valve mechanism 90, when in a closed position, prevents water 15 in the shaft 20 from reaching the bottom end 24 of the shaft 20. In an open position, the valve mechanism 90 allows water 15 to flow from the shaft 20 into the bottom end 24 of the shaft 20, and then out through the spike 40. In one embodiment of the invention, the valve mechanism 90 is a ball valve having a buoyant ball 92 captured within the bottom end 24 of the shaft 20. A seal 93 within the shaft 20 is adapted to receive the ball 92 against a lower side thereof to close the valve 90 (FIG. 2). In another embodiment, the valve mechanism is an electronic motor or solenoid-driven valve (not shown).

A moisture detection means 100 is further preferably included for detecting the moisture content of the soil 18. The moisture detection means 100 is in electronic communication with a control circuit 110, which is powered by a power source 120 and regulates the position of the valve mechanism 90 based upon electronic signals received from the moisture detection means 100 (FIG. 2). Such a moisture detection means 100 may be an electro-resistive probe 105 that correlates moisture to conductivity therethrough, or similar moisture-detecting sensor.

The shading 50 may further include at least one flexible solar cell 130 on at least one panel 55 thereof for charging a rechargeable battery 140 of at least one lantern 150 (FIGS. 1 and 2). Each lantern 150 is fixed to the shading structure 50 and connected to a lamp circuit 160 that supplies power from the battery 140 to a light emitting means 170 of the lantern 150 when a photovoltaic sensor 180 of the lamp circuit 160 detects an absence of ambient light. Alternately, the lantern 150 may include the solar cell 130 instead of the at least one panel 55. As such, in dark conditions, each lantern will light the plant 19 and the surrounding areas. The light emitting means 170 may be a conventional incandescent bulb, an LED, or the like.

In one embodiment, a shaft clamping means 200 fixed proximate the bottom end 24 of the shaft 20 is adapted for clamping and retaining the device 10 onto a fixed object 210, such as the rim of a plant pot, or the like. The clamping means 200 may be a C-clamp (as shown), a spring-clamp, or the like.

In use, the bottom end 24 of the shaft 20 is inserted into the soil 18 proximate the plant 19. If necessary, the shaft clamping means 200 may be fixed to the fixed object 210. Water 15 may be introduced, either manually or by rainfall, into the top end 22 of the shaft 20 for dispensing through the spike 40 to wet the soil 18. The shading structure 50 may be positioned to provide a selected amount of shade to the plant 19, or none at all, as desired, by either deploying or collapsing the umbrella 70, or setting the umbrella 70 between the deployed or collapsed positions as desired. The moisture detection means 100 may be inserted into the soil 18 to regulate the amount of water 15 that the valve mechanism 90 allows into the soil 18 via the spike 40.

While a particular form of the invention has been illustrated and described, it will be apparent that various modifications can be made without departing from the spirit and scope of the invention. For example, the exact type of valve mechanism 90 may be any suitable valve structure as known in the art. Likewise, the specific type of moisture detection mean 100 may be any type of suitable moisture detector known in the art. Accordingly, it is not intended that the invention be limited, except as by the appended claims.

What is claimed is:

1. A plant watering and shading device comprising:
an elongated substantially hollow shaft having a top end and a bottom end, the top end terminating in an opening for receiving water, the bottom end terminating in a soil-penetrating spike, the spike including at least one aperture therein for allowing water to pass from the inside of the hollow shaft therethrough;
a shading structure comprising at least one non-transparent panel attached at one portion thereof to a shaft attachment means;
whereby with the bottom end of the shaft inserted into soil proximate a plant, water may be introduced into the top end of the shaft for dispensing through the spike to wet the soil, and the shading structure may be positioned to provide shade to the plant.

2. The plant watering and shading device of claim 1 wherein the shading structure is in the form of an umbrella, the umbrella capable of being selectively placed in a deployed position or a collapsed position around the shaft, the shaft attachment means being a first annular collar having an aperture therethrough for receiving the shaft, the first collar being fixed to the shaft.

3. The plant watering and shading device of claim 2 wherein the first collar includes a shaft locking means for selectively fixing the position of the first collar on the shaft.

4. The plant watering and shading device of claim 3 wherein the umbrella additionally includes a second collar slidable on the shaft independently from the first collar, the second shaft attached to an umbrella deployment mechanism for selectively deploying or collapsing the umbrella, the second collar having a shaft locking means for fixing the position of the second collar on the shaft.

5. The plant watering and shading device of claim 1 further including a valve mechanism within the hollow shaft proximate the bottom end thereof, the valve mechanism in a closed position preventing water in the shaft from reaching the bottom end of the shaft, and the valve mechanism in an open position allow water to flow from the shaft to the bottom end of the shaft.

6. The plant watering and shading device of claim 5 wherein the valve mechanism is a ball valve having a buoyant ball captured within the bottom end of the shaft, and a seal within the shaft adapted to receive the ball against a lower side thereof to close the valve.

7. The plant watering and shading device of claim 5 further including a moisture detection means in electronic communication with a control circuit, the control circuit powered by a power source and regulating the position of the valve mechanism based upon electronic signals received from the moisture detection means.

8. The plant water and shading device of claim 7 wherein the moisture detection means is an elongated electric moisture probe adapted to be inserted into the soil, the probe having at least one flexible conductor for electrically connecting the probe to the control circuit.

9. The plant watering and shading device of claim 1 wherein the at least one panel further includes at least one solar cell, each solar cell for charging a battery of at least one lantern, each lantern being fixed to the shading structure and connected to a lamp circuit that supplies power from the battery to a light emitting means of the lantern when a photovoltaic sensor of the lamp circuit detects little ambient light.

10. The plant watering and shading device of claim 1 further including a cover adapted for attaching to the funnel-shaped opening at the top end of the shaft for preventing water from filling the shaft.

11. The plant watering and shading device of claim 1 further including a shaft clamping means fixed proximate the bottom end of the shaft, the shaft clamping means adapted for clamping and retaining the device onto the rim of a planting pot.

12. The plant watering and shading device of claim 1 wherein the shaft includes an upper shaft having the top end and a lower shaft having the bottom end, the lower shaft having an outside dimension of less than an inside dimension of the upper shaft, such that the lower shaft may be co-axially inserted into the upper shaft, an elastomeric gasket being further included to prevent water from leaking between the upper and lower shafts, whereby the overall height of the shaft may be selectively adjusted by sliding the lower shaft a desired distance into the upper shaft.

13. The plant watering and shading device of claim 12 wherein the lower shaft further includes a water-proof, flexible, collapsible portion fixed to the upper shaft whereby water is prevented from leaking from the lower shaft into the upper shaft.
